(19) United States
(12) Patent Application Publication
(10) Pub. No.: US 2010/0112298 A1
(43) Pub. Date: May 6, 2010

(54) METHOD FOR MAKING HOUSING AND HOUSING THEREOF

(75) Inventors: FENG-YUEN DAI, Shindian (TW); YUNG-TA LO, Shindian (TW); CHWAN-HWA CHIANG, Shindian (TW); JING HAN, Shenzhen City (CN); QI-QI YAN, Shenzhen City (CN); BAO-SHEN ZHANG, Shenzhen City (CN); YONG QIAO, Shenzhen City (CN); WEI LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/563,233

(22) Filed: Sep. 21, 2009

(30) Foreign Application Priority Data
Oct. 30, 2008 (CN) 200810305305.8

(51) Int. Cl. B32B 3/10; C25D 5/02

(52) U.S. Cl. 428/172; 205/122

(57) ABSTRACT

A method for making housing, comprising: providing a substrate; etching the substrate to form a plurality of grooves on a surface of the substrate; micro-arc oxidizing the substrate to form a micro-arc oxide film in the grooves and on the surface of the substrate; and polishing the micro-arc oxide film formed on the surface of the substrate. A housing, comprising: a substrate, the substrate having a plurality of grooves defined therein; and a micro-arc oxide film formed on the surface of the substrate and in the grooves; wherein the oxide film formed on the surface of the substrate is polished to present a glossy appearance.

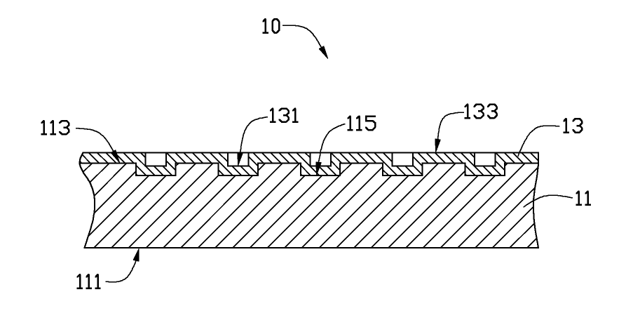

### CROSS-REFERENCE TO RELATED APPLICATIONS

This application is one of the two related co-pending U.S. patent applications listed below. All listed applications have the same assignee. The disclosure of each of the listed applications is incorporated by reference into all the other listed applications.

| Attorney | | |
|---|---|---|
| Docket No. | Title | Inventors |
| US23419 | HOUSING AND METHOD FOR | FENG-YUEN |
| | MAKING THE SAME | DAI et al. |
| US23422 | METHOD FOR MAKING HOUSING | FENG-YUEN |
| | AND HOUSING THEREOF | DAI et al. |

### BACKGROUND

1. Technical Field

The present disclosure relates to method for making housings and housings thereof.

2. Description of Related Art

Micro-arc oxidation is a surface treatment process that oxidizes a metal surface to form a micro-arc oxide film. Micro-arc oxide films have similar appearance and physical properties as ceramics and possess high rigidity. However, the micro-arc oxide film can only present matte appearance and cannot decorate the housing with more attractive gloss.

Therefore, there is room for improvement within the art.

### BRIEF DESCRIPTION OF THE DRAWING

Many aspects of the housing can be better understood with reference to the following drawing. The components in the drawing are not necessarily drawn to scale, the emphasis instead being placed upon clearly illustrating the principles of the housing.

The FIGURE is a cross-sectional view of an exemplary embodiment of a housing.

### DETAILED DESCRIPTION

Referring to the FIGURE, in an exemplary embodiment, a method for making a housing 10 may generally comprise the following steps: providing a substrate; etching the substrate to form a plurality of grooves on one surface of the substrate; micro-arc oxidizing the substrate to form a micro-arc oxide film in the grooves and on the surface of the substrate; and polishing the micro-arc oxide film formed on the surface of the substrate. Each step is described in more detail below.

A substrate 11 is provided. The substrate 11 is made of metal selected from a group consisting of aluminum, aluminum alloy, magnesium, magnesium alloy, titanium, and titanium alloy.

The substrate 11 is etched to form a plurality of grooves 115. These grooves 115 define a predetermined pattern. The pattern may be a logo or a decorative pattern. The etching step may be carried out by chemical eroding or CNC numerical control machine engraving the surface of the substrate 11.

The substrate 11 is micro-arc oxidized to form a micro-arc oxide film 13 on the surface of the grooves 115 and the substrate 11. The oxidation process may comprise the following steps:

The substrate 11 is firstly de-dusted in an alkaline solution for about 10 minutes. Dust adhering to the substrate 11 is removed by the de-dusting process. After the de-dusting process, the substrate 11 is rinsed in water.

The substrate 11 is then micro-arc oxidized in an electrolyte contained in a stainless steel tank to form the micro-arc oxide film 13 on the surface of the substrate 11 and in the grooves 115. The electrolyte includes at least one of phosphate salt, borate salt, silicate salt, aluminate salt, and alkali metal hydroxide. The electrolyte may further include at least one of tungstate salt, vanadate salt, ammonium metavanadate, sulfate salt, sodium fluoride, cobalt acetic, sorbitol, and glycerol. The pH of the electrolyte may be in a range of about 10.5-12.5. The temperature of the electrolyte is about 20-50° C. During the oxidation process, a bidirectional voltage pulse including a forward pulse and a reverse pulse is applied to the substrate 11 and the stainless steel tank for about 30-180 minutes to develop the micro-arc oxide film 13. The pulse width of the bidirectional pulse is about 1000-10000 microseconds (μs). The pulse interval of the bidirectional pulse is about 300-2000 μs. During the forward pulse, the voltage gradually grows to a positive voltage in a range of about 450-650 volts. During the reverse pulse, the voltage gradually grows to a negative voltage in a range of about −30˜−200 volts.

After the micro-arc oxidation process, the substrate 11 having the micro-arc oxide film 13 is rinsed in water and baked in an oven.

After the oxidation process, the micro-arc oxide film 13 formed on the surface of the substrate 11 is mechanically polished to present a glossy appearance. The polishing process may comprise a rough polishing step, a secondary polishing step, and a precise polishing step. The rough polishing step may be carried out by a copper polishing disk for about 4-7 minutes. The secondary polishing step may be carried out by a resin polishing disk for about 1-4 minutes. The precise polishing step may be carried out by a polyurethane polishing disk for about 0.5-1.5 minutes. The micro-arc oxide film 13 formed on the surface of the grooves 115 is not polished and present a matte appearance.

The micro-arc oxide film 13 undergoes a sealing process to seal the micro pores of the oxide film 13 to prevent the film 13 from being contaminated. The sealing agent used in the sealing process may be a mixture of silicone resin and a diluting agent. The silicone resin may advantageously be methyl hydrogen silicone fluid. The diluting agent may be organic solvent selected from a group consisting of isopropyl alcohol, toluene, xylene and acetone. The mass ratio between the silicone resin and the organic solvent is about 1˜2:0.5˜1.5. The sealing process is carried out by uniformly daubing the micro-arc oxide film 13 with the sealing agent to make some of the sealing agent be adsorbed into the micro pores of the oxide film 13. After the sealing process, the film 13 is cleaned by using a dry clean wiper to remove the extra sealing agent on the film 13 that was not adsorbed. After the cleaning process, the film 13 is baked in an oven.

Referring to the FIGURE, in an exemplary embodiment, the housing 10 made by the above mentioned method includes a substrate 11 and a micro-arc oxide film 13 formed on the substrate 11.

The substrate 11 includes a first surface 111 and a second surface 113 on an opposite site to the first surface 111. The second surface 113 is defined a plurality of grooves 115 therein. The micro-arc oxide film 13 is formed on the second surface 113 and in the grooves 115. These grooves 115 define a predetermined pattern of the housing 10. The pattern may be a logo or a decorative pattern. The grooves 115 may be formed by chemical eroding or CNC numerical control machine engraving the substrate 11. The substrate 11 is made of metal selected from a group consisting of aluminum, aluminum alloy, magnesium, magnesium alloy, titanium and titanium alloy.

The micro-arc oxide film 13 formed in the grooves 115 forms a hollowed plane 131, and the oxide film 13 formed on the substrate 11 forms a raised plane 133. The raised plane 133 is mechanically polished to present a glossy appearance. The hollowed plane 131 is not polished to present a matte surface like the micro-arc oxide film 13.

The exemplary housing 10 forms a raised plane 133 to give a glossy appearance and a hollowed plane 131 to give a matte appearance which, for example, produce a strong or subtle contrast appearance to improve the appearance attraction of the housing 10.

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A method for making housing, comprising:
providing a substrate;
etching the substrate to form a plurality of grooves on a surface of the substrate;
micro-arc oxidizing the substrate to form a micro-arc oxide film in the grooves and on the surface of the substrate; and
polishing the micro-arc oxide film formed on the surface of the substrate.

2. The method as claimed in claim 1, wherein the etching step is carried out by chemical eroding or CNC numerical control machine engraving the surface of the substrate.

3. The method as claimed in claim 1, wherein the micro-arc oxidation process is carried out in an electrolyte containing at least one of phosphate salt, borate salt, silicate salt, aluminate salt, and alkali metal hydroxide.

4. The method as claimed in claim 3, wherein the electrolyte contains at least one of tungstate salt, vanadate salt, sulfate salt, sodium fluoride, cobalt acetic, sorbitol, and glycerol.

5. The method as claimed in claim 4, wherein the electrolyte has a pH of about 10.5-12.5.

6. The method as claimed in claim 1, wherein the micro-arc oxidation process employs a bidirectional voltage pulse including a forward pulse having a positive voltage in a range of about 450-650 volts and a reverse pulse having a negative voltage in a range of about −30˜−200 volts; the pulse width of the bidirectional pulse is about 1000-10000 μs, the pulse interval of the bidirectional pulse is about 300-2000 μs.

7. The method as claimed in claim 1, wherein the polishing process includes a rough polishing step, a secondary polishing step, and a precise polishing step.

8. The method as claimed in claim 1, wherein the substrate is made of metal selected from a group consisting of aluminum, aluminum alloy, magnesium, magnesium alloy, titanium, and titanium alloy.

9. The method as claimed in claim 1, wherein the method further includes a de-dusting process for the substrate prior to the micro-arc oxidation process.

10. The method as claimed in claim 1, wherein the method further includes a sealing process for the micro pores of the micro-arc oxide film after the polishing process.

11. A housing, comprising:
a substrate, the substrate having a plurality of grooves defined therein; and
a micro-arc oxide film formed on the surface of the substrate and in the grooves;
wherein the oxide film formed on the surface of the substrate is polished to present a glossy appearance.

12. The housing as claimed in claim 11, wherein the substrate is made of metal selected from a group consisting of aluminum, aluminum alloy, magnesium, magnesium alloy, titanium, and titanium alloy.

13. The housing as claimed in claim 11, wherein the oxide film formed in the grooves forms a hollowed plane, and the oxide film formed on the surface of the substrate forms a raised plane.

14. The housing as claimed in claim 13, wherein the raised plane is mechanically polished to present a glossy appearance.
